(19) United States
(12) Patent Application Publication
(10) Pub. No.: US 2018/0188380 A1
(43) Pub. Date: Jul. 5, 2018

(54) CONTROLLING SAMPLING RATE IN NON-CAUSAL POSITIONING APPLICATIONS

(71) Applicant: QUALCOMM Incorporated, San Diego, CA (US)

(72) Inventors: Sai Pradeep VENKATRAMAN, Santa Clara, CA (US); Weihua GAO, Santa Jose, CA (US); William MORRISON, San Francisco, CA (US)

(21) Appl. No.: 15/393,361

(22) Filed: Dec. 29, 2016

(51) Int. Cl. G01S 19/34; G01S 19/23

(52) U.S. Cl. CPC G01S 19/34; G01S 19/426; G01S 19/235

(57) ABSTRACT

Techniques for controlling sampling rates in non-causal positioning applications are provided. An example method for controlling a sampling rate in a mobile device includes determining one or more positions based on external signal information, such that the one or more positions are determined at a position fix rate, storing sensor information associated with one or more sensors at a sensor sampling rate, calculating a position estimate based on a non-causal analysis of the one or more positions and the sensor information, such that the non-causal analysis utilizes past, present and future positions and the corresponding past, present and future sensor information, comparing the position estimate to a Quality of Service (QoS) value, and modifying the position fix rate based on the comparison of the position estimate to the QoS value.

### BACKGROUND

Positioning systems can utilize various types of information to calculate location of an object. In general, a positioning system will consume significant power when satellite and terrestrial radio signaling position methods are used. Some positioning system may utilize sensor information and rely on dead reckoning calculations to reduce the amount of power consumed. For example, an indoor positioning system may use dead reckoning calculations based on sensor data gathered from a user's cell phone to determine the location of the user within a building. These dead reckoning sensors may also consume significant levels of power if the sensor sampling rate is too high, which can be a problem for cell phones and other mobile devices with a limited power budget. A Quality of Service (QoS) may be reduced for some navigation applications. For such applications, there is a need to determine appropriate sampling rates for radio navigation methods (e.g., satellite and terrestrial) and sensor based navigation methods to conserve power.

### SUMMARY

An example of a method for controlling a sampling rate in a mobile device according to the disclosure includes determining one or more positions based on external signal information, such that the one or more positions are determined at a position fix rate, storing sensor information associated with one or more sensors at a sensor sampling rate, calculating a position estimate based on a non-causal analysis of the one or more positions and the sensor information, such that the non-causal analysis utilizes past, present and future positions and the corresponding past, present and future sensor information, comparing the position estimate to a Quality of Service (QoS) value, and modifying the position fix rate based on the comparison of the position estimate to the QoS value.

Implementations of such a method may include one or more of the following features. The sensor sampling rate may be modified based on the comparison of the position estimate to the QoS value. The external signal information may be a signal received from a Global Navigation Satellite System (GNSS). The external signal information may be a terrestrial position signal. The mobile device may be configured to determine the one or more positions based on a Received Signal Strength Indication (RSSI) or a Round Trip Time (RTT) associated with the terrestrial position signal. The QoS value may include an accuracy component. The QoS value may include a response time component. Modifying the position fix rate may include reducing the position fix rate from 1 Hz to less than 0.5 Hz.

An example of an apparatus according to the disclosure includes a memory, at least one processor operably coupled to the memory and configured to determine one or more positions based on external signal information, such that the one or more positions are determined at a position fix rate, store sensor information associated with one or more sensors at a sensor sampling rate in the memory, calculate a position estimate based on a non-causal analysis of the one or more positions and the sensor information, such that the non-causal analysis utilizes past, present and future positions and the corresponding past, present and future sensor information, compare the position estimate to a Quality of Service (QoS) value, and modify the position fix rate based on the comparison of the position estimate to the QoS value.

Implementations of such an apparatus may include one or more of the following features. The at least one processor may be further configured to modify the sensor sampling rate based on the comparison of the position estimate to the QoS value. A Satellite Positioning System (SPS) receiver configured to receive external signal information from a Global Navigation Satellite System (GNSS). A wireless communication interface configured to receive external signal information as a terrestrial position signal. The at least one processor may be configured to determine the one or more positions based on a Received Signal Strength Indication (RSSI) or a Round Trip Time (RTT) associated with the terrestrial position signal. The QoS value may include an accuracy component. The QoS value may include a response time component. The at least one processor may be configured to modify the position fix rate by reducing the position fix rate from 1 Hz to less than 0.5 Hz.

An example of an apparatus for controlling a sampling rate in a mobile device according to the disclosure includes means for determining one or more positions based on external signal information, such that the one or more positions are determined at a position fix rate, means for storing sensor information associated with one or more sensors at a sensor sampling rate, means for calculating a position estimate based on a non-causal analysis of the one or more positions and the sensor information, such that the non-causal analysis utilizes past, present and future positions and the corresponding past, present and future sensor information, means for comparing the position estimate to a Quality of Service (QoS) value, and means for modifying the position fix rate based on the comparison of the position estimate to the QoS value.

An example of a non-transitory processor-readable storage medium according to the disclosure comprises processor-readable instructions configured to cause one or more processing units to control a sampling rate in a mobile device, including code for determining one or more positions based on external signal information, such that the one or more positions are determined at a position fix rate, code for storing sensor information associated with one or more sensors at a sensor sampling rate, code for calculating a position estimate based on a non-causal analysis of the one or more positions and the sensor information, such that the non-causal analysis utilizes past, present and future positions and the corresponding past, present and future sensor information, code for comparing the position estimate to a Quality of Service (QoS) value, and code for modifying the position fix rate based on the comparison of the position estimate to the QoS value.

Items and/or techniques described herein may provide one or more of the following capabilities, as well as other capabilities not mentioned. A positioning device, such as a mobile device, may execute a positioning application. The positioning application may be associated with a Quality of Service (QoS) value. The QoS value may have an accuracy component and a response time component. The positioning device may receive external positioning information such as from a Satellite Positioning System (SPS) or other terrestrial systems (e.g., access points) to determine a current position. The positioning device may be configured to determine dead reckoning positions based on inertial sensor information. Position and sensor information may be analyzed with a non-causal process. The non-causal process may use past, present and future position and sensor information to compute a non-causal position estimate. Context information, such as map data, may be used in determining the non-causal position estimate. The frequency of satellite or terrestrial fixes and sensor input may be modified based on the QoS in view of the non-causal position estimate. Power may be conserved by decreasing the sample rates. Sensor accuracy may be improved by using future sensor measurements. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a simplified illustration of an example positioning system.

FIG. 2 is an example input/output diagram illustrating how embodiments can utilize sensor and other information in dead reckoning calculations to provide a position output.

FIG. 3 is a sample trajectory with position estimates based on a non-causal analysis of signal and sensor information.

FIG. 4 is an example of position estimates based on combined Global Navigation Satellite System (GNSS), sensor and map-aided position accuracy.

FIG. 5 is a flow diagram of an example process for controlling a sampling rate in a mobile device.

FIG. 6 is a flow diagram of an example method for controlling sampling rates based on a non-causal quality of service value.

FIG. 7 is a block diagram of an example of a mobile device.

### DETAILED DESCRIPTION

Techniques are discussed herein for estimating the position of a mobile device. For example, a positioning application may specify a Quality of Service (QoS) for position history data (i.e., a non-causal QoS). Non-causal positioning may utilize measurements from the past, present and future to provide location estimates (e.g. using an forward-backward EKF smoother to improve past position estimates based on future position estimates). An estimate of a combined GNSS, sensor, and map-aided position accuracy may be maintained continuously and used to test a hypothesis that new GNSS is necessary for accuracy of past, present & future positions to meet a non-causal QoS. Significant GNSS power savings may be obtained with non-causal positioning. For example, in a pedestrian application, the position accuracy of non-causal 1/60 Hz GNSS combined with inertial sensor data (e.g., Pedestrian Dead Reckoning (PDR)) may be comparable to causal 1 Hz GNSS. In an example, a positioning system may be configured to select a frequency of GNSS required to meet a non-causal QoS based on estimated sensor error growth, GNSS quality, and availability of map-aiding. Sensor accuracy can be improved using future sensor measurements. Sensor sample rates can be reduced as compared to a causal estimator. These examples, however, are not exhaustive.

Different techniques may be used to estimate the location of a mobile device such as a cell phone, personal digital assistant (PDA), tablet computer, personal media player, gaming device, and the like, according to the desired functionality of the mobile device. For example, some mobile devices may process signals received from a Satellite Positioning System (SPS) to estimate their locations for navigation, social media location information, location tracking, and the like. However, sometimes there are certain areas where navigation signals from an SPS may not be available, such as in certain indoor locations.

A mobile device may estimate its location within an area where navigation signals transmitted from an SPS are not available. Positioning systems (e.g., indoor positioning systems) can enable a mobile device to transmit a signal to an access point and measure a length of time until a response signal from the access point is received. (As provided herein, an access point may comprise a device that allows wireless communication devices to communicate with a network.) A range from the mobile device to the access point may be determined based upon the measured length of time between transmission of a signal from the mobile device and receipt of a response signal at the mobile device (e.g., round trip time (RTT)). Alternatively, signal strength of a signal received from the access point may be measured and a range from the mobile device to the access point may be estimated based on the measured signal strength (e.g., received signal strength indication (RSSI)). In this manner, a location of the mobile device can be estimated.

Additional data can complement the location estimates by providing additional information regarding movement that can be used, for example, in dead reckoning calculations. This additional data can come from one or more orientation sensors such as a gyroscope, a magnetometer, an accelerometer, a camera, and the like. Other sensors, such as an altimeter, may also be used. Increasing the sampling rates of these various sensors may improve position accuracy at the cost of increasing the power consumed by a mobile device. Some applications may be less dependent on absolute real time positioning information (e.g., run mapping software, pedestrian navigation) and may utilize non-causal analysis of signal and sensor data to improve position estimates and determine future sensor sampling rates.

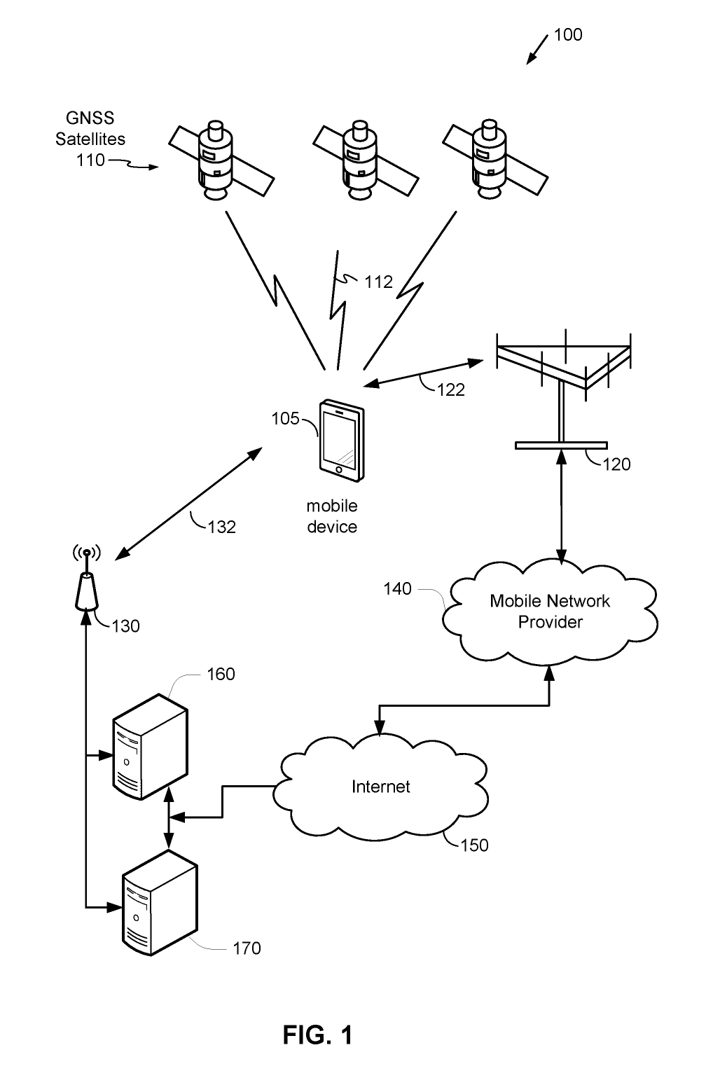

Referring to FIG. 1, a simplified illustration of an example positioning system 100 is shown. The positioning system can include a mobile device 105, GNSS satellites 110, a base transceiver station 120, mobile network provider 140, an access point 130, a location server 160, a map server 170, and the Internet 150. It should be noted that FIG. 1 provides only a generalized illustration of various components, any or all of which may be utilized as appropriate. Furthermore, additional or duplicate components may be used, and the components may be combined, separated, substituted, and/or omitted, depending on desired functionality.

In the positioning system 100, a location of the mobile device 105 can be determined in a variety of ways. In some embodiments, for example, the location of the mobile device 105 can be calculated using triangulation and/or other positioning techniques with information transmitted from the GNSS satellites 110. In these embodiments, the mobile device 105 may utilize a receiver specifically implemented for use with the GNSS that extracts position data from a plurality of signals 112 transmitted by GNSS satellites 110. Transmitted satellite signals may include, for example, signals marked with a repeating pseudo-random noise (PN) code of a set number of chips and may be located on ground based control stations, user equipment and/or space vehicles. Satellite positioning systems may include such systems as the Global Positioning System (GPS), Galileo, Glonass, Compass, Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like.

Embodiments may also use communication and/or positioning capabilities provided by the base transceiver station 120 and the mobile network provider 140 (e.g., a cell phone service provider), as well as the access point 130. Communication to and from the mobile device 105 may thus also be implemented, in some embodiments, using various wireless communication networks. In one example, mobile device 105 may communicate with a cellular communication network by transmitting wireless signals to, or receiving wireless signals from a cellular transceiver 120 which may comprise a wireless base transceiver subsystem (BTS), a Node B or an evolved NodeB (eNodeB) over wireless communication link 122. Similarly, mobile device 105 may transmit wireless signals to, or receive wireless signals from a local transceiver (e.g., an access point 130) over wireless communication link 132. The mobile network provider 140, for example, can comprise such as a wide area wireless network (WWAN). The access point 130 can be part of a wireless local area network (WLAN), a wireless personal area network (WPAN), and the like. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may implement Long Term Evolution (LTE), LTE Advanced, and so on. LTE, LTE Advanced, GSM, and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may also be an IEEE 802.11x network, and a WPAN may be a Bluetooth network, an IEEE 802.15x, or some other type of network. The techniques described herein may also be used for any combination of WWAN, WLAN and/or WPAN.

The mobile network provider 140 and/or the access point 130 may further communicatively connect the mobile device 105 to the Internet 150. Other embodiments may include other networks in addition, or as an alternative to, the Internet 150. Such networks can include any of a variety of public and/or private communication networks, including wide area network (WAN), local area network (LAN), and the like. Moreover, networking technologies can include switching and/or packetized networks utilizing optical, radio frequency (RF), wired, satellite, and/or other technologies.

As described previously, the access point 130 may be used for wireless voice and/or data communication via the communication link 132 with the mobile device 105, as well as independents sources of position data, e.g., through implementation of trilateration-based procedures based, for example, on RTT and/or RSSI measurements. The access point 130 can be part of a WLAN that operates in a building to perform communications over smaller geographic regions than a WWAN. The access point 130 can be part of a WiFi network (802.11x), cellular piconets and/or femtocells, Bluetooth network, and the like. The access point 130 can also form part of a Qualcomm indoor positioning system (QUIPS™). Embodiments may include any number of access point 130, any of which may be a movable node, or may be otherwise capable of being relocated.

The mobile device 105 can include a variety of sensors, some or all of which can be utilized in dead reckoning calculations to complement and/or further improve the accuracy of location determinations. These dead reckoning calculations can be made by the mobile device 105 and/or the location server 160. Sensors may be intelligently sampled to provide the necessary information for dead reckoning calculations, while keeping power consumption of the mobile device at a minimum.

To facilitate the intelligent sampling of the sensors, the map server 170 can provide location information such as maps, motion models, context determinations, and the like, which can be used by the location server 160 and/or the mobile device 105 to determine a sampling strategy for one or more of the mobile device's sensors. In some embodiments, for example, the map server 170 associated with a building can provide a map to a mobile device 105 when the mobile devices approaches and/or enters the building. The map data, which can comprise a layout of the building (indicating physical features such as walls, doors, windows, etc.), can be sent to the mobile device 105 from the map server 170 via the access point 130, and/or via the Internet 150, the mobile network provider 140, and the base transceiver station 120. Alternatively, sensor and/or derivative data (e.g., pedometer count), can be sent to the map server 170 and/or the location server 160 for determination of the location of the mobile device 105.

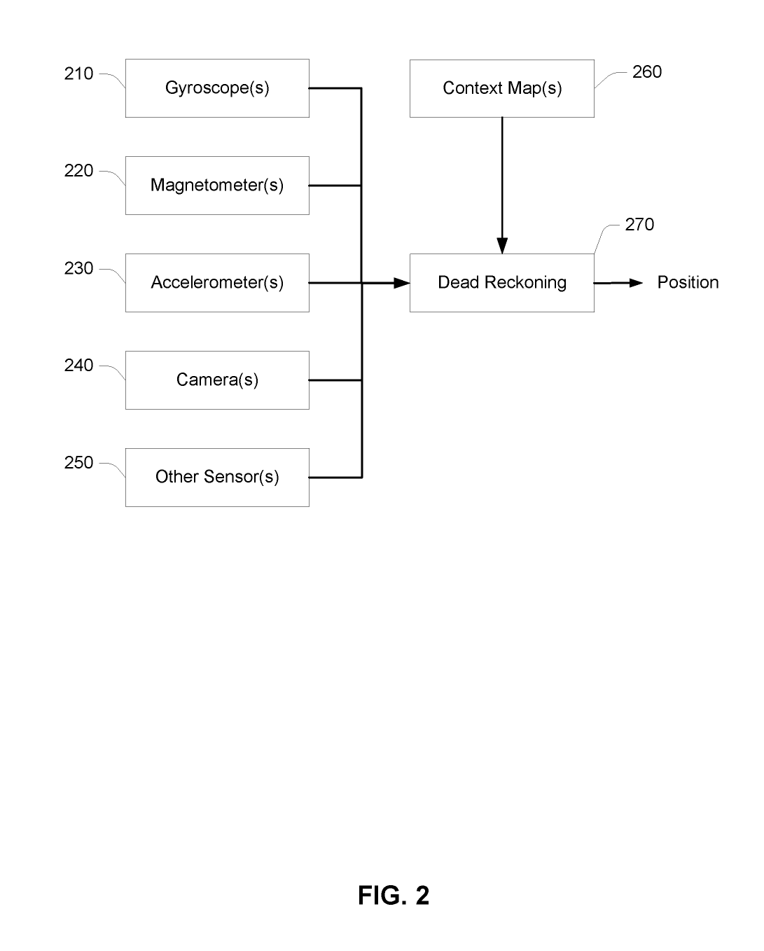

Referring to FIG. 2, an example input/output diagram illustrating how embodiments described herein can utilize sensor and other information in dead reckoning calculations to provide a position output is shown. A mobile device can have one or more orientation sensors, including one or more gyroscope(s) 210, magnetometer(s) 220 (e.g., compass(es)), accelerometer(s) 230, and/or camera(s) 240. Data from one or more other sensor(s) 250 can also be used. Other sensor(s) can include, for example, altimeter(s), microphone(s), light sensor(s), proximity sensor(s), and the like.

As stated above, dead reckoning 270 can be calculated by the mobile device 105 and/or the location server 160. Depending on the desired functionality, the dead reckoning calculation can use raw sensor data and/or derivative data. Derivative data can include summarized data or conclusions made from the raw data. For example, derivative data can include a calculated number of steps based on accelerometer data, the angle of a turn based on gyroscope data, and the like. Some embodiments may use derivative data in instances where the transmittal of such data can further conserve power of the mobile device. For example, in embodiments where dead reckoning 270 is computed on a location server 160, the mobile device may transmit derivative sensor data to the location server 160 to make the calculation.

Context map(s) 260 can also be used in positioning calculations. Context maps 260 can include contextual information, such as a location type, associated with a particular location and/or physical structure associated with a map. For example, a context map 260 can indicate that certain locations are part of a pathway, in which motion is likely to be limited to a single dimension. Locations within a field on the other hand, may indicate that movement may be in any of a wide variety of directions. The context map(s) 260 may also indicate an expected activity engaged in by a user of the mobile device based on the location. For example, the user may be expected to jog or run when on a track.

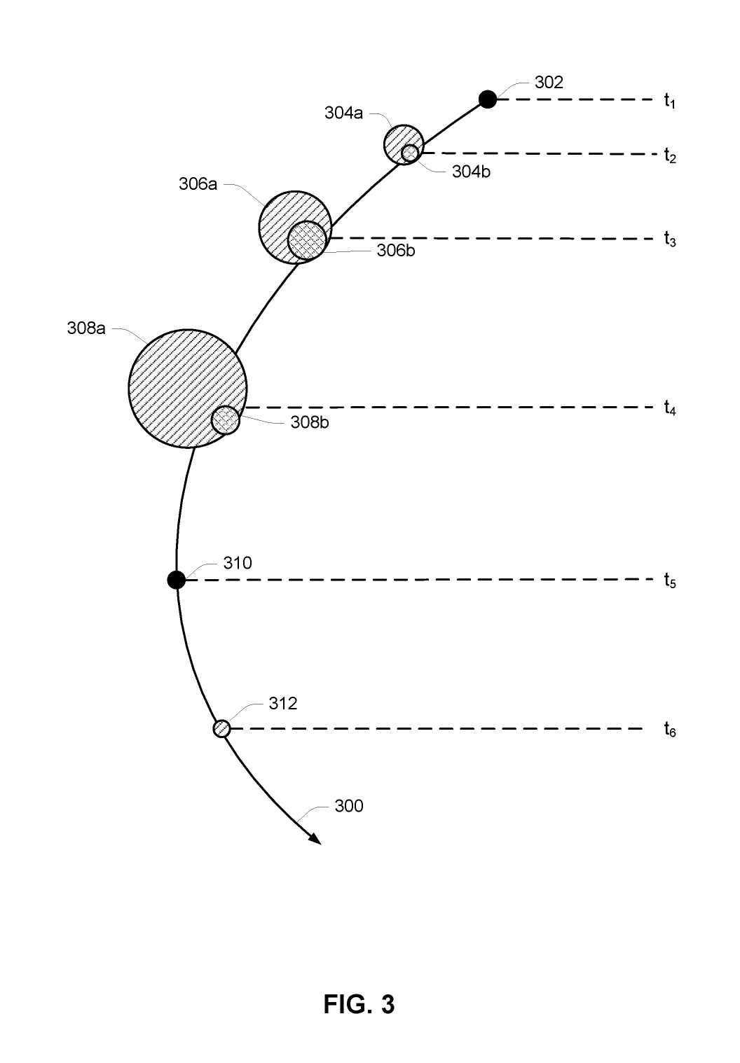

Referring to FIG. 3, a sample trajectory 300 with position estimates based on a non-causal analysis of signal and sensor information is shown. A mobile device 105 begins at time t₁ at a first GNSS position 302. For purposes of this example, the GNSS positions may also be other terrestrial positioning signals (e.g., RTT, RSSI) considered to be accurate and within an expected QoS for an application executing on the mobile device 105. As used herein, the QoS may indicate an accuracy of a position estimate, a response time (e.g., an acceptable delay to obtain a position estimate), or a combination of both. The mobile device 105 may be configured with an initial GNSS sampling rate, such that GNSS positional fixes are determined at time t₁ and time t₅. The intermediate position estimates are determined based on inertial sensor data, which may also have an initial sampling rate. As the mobile device 105 progresses along the trajectory 300, a first dead reckoning (DR) position 304a is determined at time t₂. The first DR position 304a may be based on inertial sensor information received from one or more gyroscope(s) 210, magnetometer(s) 220, accelerometer(s) 230, and/or other sensors. In an example, sensor fusion techniques may be used to determine the first DR position 304a. The area of the first DR position 304a represents an uncertainty of the position estimate, which may be based on sensor sensitivity/calibration, noise in the sensor signal, and other control parameters. The areas of the respective DR position estimates in FIG. 3 (e.g., the positional uncertainty) may be associated with a QoS value (e.g., accuracy component) for a positioning application. In an application, a comparison of the uncertainty area and a QoS value may be used to modify signal and sensor sampling rates. For example, as the mobile device 105 proceeds along the trajectory 300, at time t₃ a second DR position 306a is determined. The area of uncertainty of the second DR position 306a may increase based on accumulated error in the inertial sensors (e.g., error growth rate) as applied to the first GNSS position 302 and/or the first DR position 304a. The uncertainty of the second DR position 306a may exceed the required QoS (e.g., accuracy) for an application and the mobile device 105 may be configured in increase the GNSS sampling rate in response to the sensor error growth. In the non-causal analysis described herein, however, the mobile device 105 is configured to continuously estimate a combined GNSS, inertial sensor, and map-aided position accuracy to test a hypothesis that a new GNSS fix is necessary to increase the accuracy of past, present & future positions in order to meet the QoS. Accordingly, a third DR position 308a may be determined at time t₄ such that the uncertainty of the third DR position 308a also does not immediately impact the signal and/or sensor sampling rates (e.g., even though the uncertainty exceeds the required QoS). At time t₅, the mobile device 105 determines a second GNSS position 310 based on the initial GNSS sample rate.

Concurrent with the position determination processing described above, the mobile device 105 is also configured to determine a series of non-causal position estimates based on past, present and future location estimates. For example, a forward-backward Extended Kalman Filter (EKF) may be used to improve past position estimates based on future estimates. For example, at time t₅, the mobile device 105 may be configured to determine a third non-causal DR position 308b based on the second GNSS position 310, and a second non-causal DR position 306b based on the third non-causal DR position 308b. The EKF may be used to iteratively compute the non-causal DR positions along the trajectory 300. For example, a first non-causal DR position 304b may be determined based on the first GNSS position 302 and the second non-causal DR position 306b. The uncertainty values associated with the non-causal DR positions may be compared to a non-causal QoS value to determine if the sampling rates for the GNSS receiver (or other terrestrial positioning receivers), and/or the inertial sensors. For example, if the uncertainty values increases, the GNSS sampling rate may increase. If the QoS value includes a prolong response time (e.g., does not require an instantaneous position estimate), then a more extensive non-causal position estimating process may be used (e.g., more iterations). In an example, if the quality of GNSS fixes decreases (i.e., the uncertainty of the position estimates for the GNSS fixes increases) such as when the mobile device 105 may enter a building, the sampling rates of the inertial sensors may be increased. The non-causal analysis may also be used to modify the measurement error variables associated with the inertial sensors. For example, improved sensor data (e.g., data with reduced initial error measurement variable) may be used in a causal estimator to determine a fourth DR position 312 at time t6 in relation to the second GNSS position 310. The process of determining non-causal positions may continue as the mobile device 105 moves along the trajectory 300 and the associated sampling rates may be adjusted based on the quality of the non-causal position estimates.

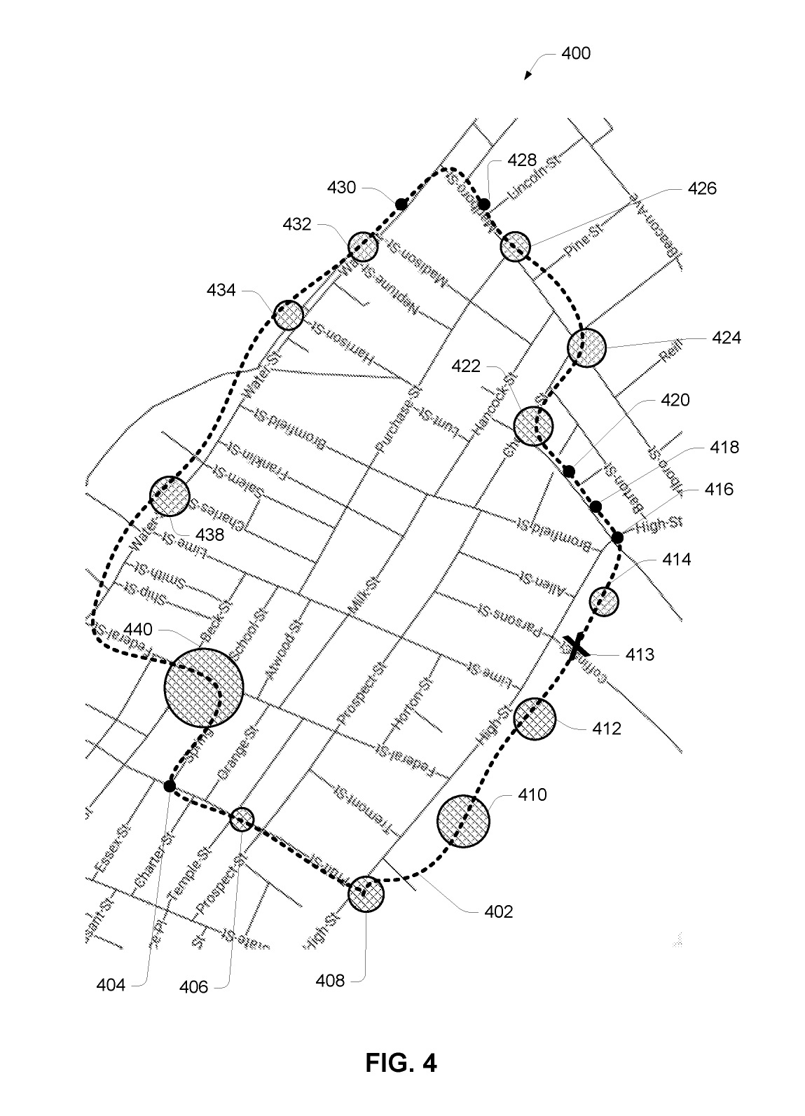

Referring to FIG. 4, an example of position estimates based on combined GNSS, sensor and map-aided position accuracy is shown. The mobile device 105 may include a context map such as the street map 400 depicted in FIG. 4. Other maps and context data, such as building plans, may also be used. The street map 400 may be used in positioning calculations. For example, the street map 400 may indicate that certain locations are streets or pathways which are likely to limit motion to a single dimension. In a pedestrian positioning application, a user may embark on a route 402 (shown as a dashed line in FIG. 4) with a positioning device (e.g., a mobile device 105). At an initial position 404 the mobile device 105 may be configured to determine one or more positions based on external signals such as GNSS or other terrestrial based methods (e.g., terrestrial position signal, RTT, RSSI). The position calculation may be determined at an initial sampling rate based on fix quality, signal strength, or other application specific parameters. The position information and the corresponding sampling rates depicted in FIG. 4 are provided to facilitate the explanation of non-causal analysis utilizing past, previous and future position estimates within a context. In operation, the GNSS or inertial sensor sample rates may vary between 10 Hz and 1/60 Hz, and thus the number (e.g., density) of position estimates would be much higher than indicated on FIG. 4. Fewer position estimates are shown in an effort not to unnecessarily crowd and complicate FIG. 4. As the user proceeds along the route 402 (in a counter-clockwise direction in FIG. 4), the mobile device 105 may be configured to store inertial sensor information at an initial rate. As previously described, the inertial sensor information may include information received from one or more gyroscope(s) 210, magnetometer(s) 220, accelerometer(s) 230, and/or other sensors. The mobile device 105 is configured to determine non-causal position estimates based on a non-causal analysis of the GNSS signals, inertial sensor information, and map data. As the user proceeds along the route, the mobile device may determine a first non-causal position estimate 406, a second non-causal position estimate 408, and a third non-causal position estimate 410. At each position estimate, a QoS value may be utilized to determine in the non-causal position estimates are sufficiently accurate and/or provided with a required response time. For example, since the non-causal position estimates utilize past, present and future signal and sensor information, as well as map context data, the third non-causal position estimate 410 may be computed with the user is actually at position ‘X’ 413. If the QoS of the third non-causal position estimate 410 is unacceptable (e.g., the area of uncertainty is too large), the mobile device 105 may be configured to increase the GNSS sampling rate. The new sampling rate need not be just a linear change (e.g., 10 Hz, 5 Hz, 1 Hz), but may also be specified based on an number of samples over a period of time (e.g., 1/60 Hz for 3 mins). The mobile device 105 may then be configured to compute a first GNSS fix 416, a second GNSS fix 418, and a third GNSS fix 420. The position estimates associated with these fixes may be modified based on the non-causal analysis and the map data. The GNSS position data, sensor information, and the map data may be used in the non-causal analysis to determine a fourth non-causal position estimate 412, a fifth non-causal position estimate 414, a sixth non-causal position estimate 422, a seventh non-causal position estimate 424, and an eighth non-causal position estimate 426. In an example, a comparison of the seventh non-causal position estimate 424 with a QoS value may indicate that additional GNSS fixes will be required to improve the DR accuracy. A fourth GNSS fix 428 and a fifth GNSS fix 430 may be obtained as the user progresses along the route 402. In an example, the accuracy of a ninth non-causal position estimate 432 may exceed the QoS expectations (i.e., the uncertainty areas are low) and the mobile device 105 may be configured to reduce the inertial sensor sampling rate at some point beyond a tenth non-causal position estimate 434. An eleventh non-causal position estimate 438 and a twelfth non-causal position estimate 440 may be based on the reduced sampling rate. In an example, the route 402 may be stored in the mobile device 105 (or a map server 170) and may be used to constrain the non-causal position estimates on a subsequent positioning session.

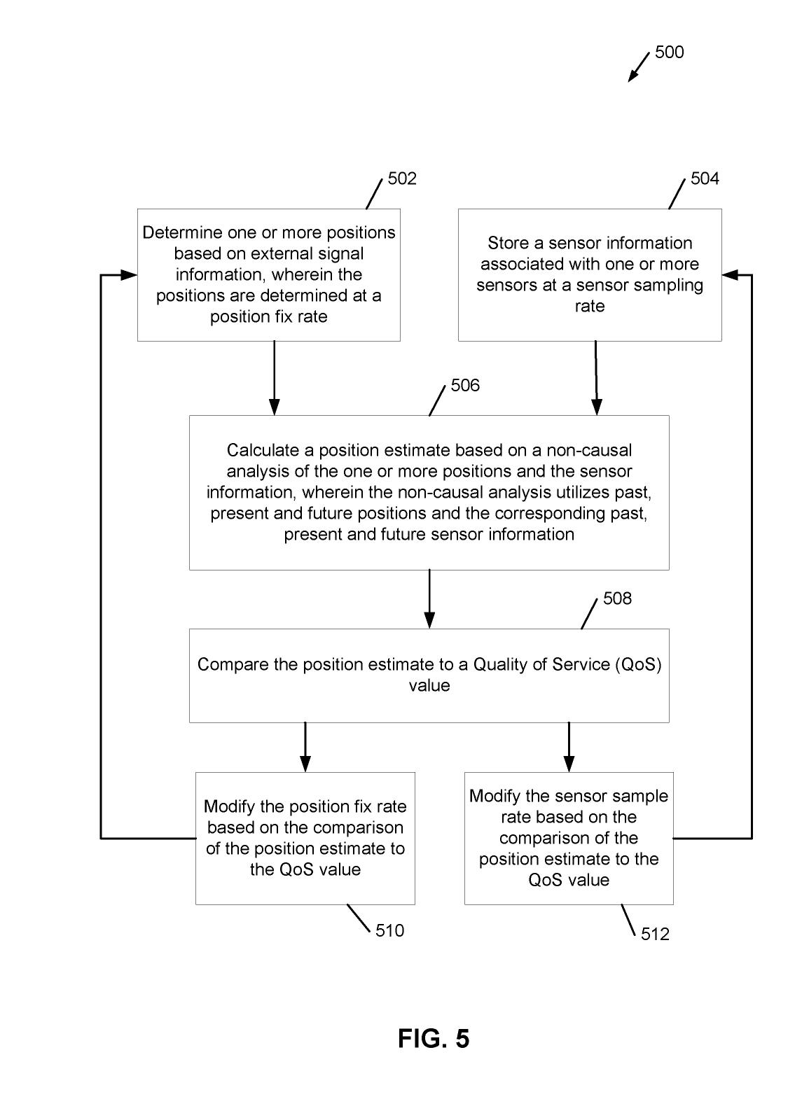

Referring to FIG. 5, with further reference to FIGS. 1-4, a process 500 for controlling sampling rates in a mobile device 105 includes the stages shown. The process 500 is, however, an example only and not limiting. The process 500 can be altered, e.g., by having stages added, removed, rearranged, combined, performed concurrently, and/or having single stages split into multiple stages. For example, the position fix rate in stage 502 and the inertial sensor sampling rate at stage 504 may occur independently at different times and at different rates. The process 500 may be performed on a mobile device 105 (e.g., local), or on a remote server (e.g., a location server 160) based on information received from the mobile device 105. In an example, the process may modify a position fix rate at stage 510 without modifying the sensor sample rate at stage 512. Still other alterations to the process 500 as shown and described are possible.

At stage 502, a mobile device 105 determines one or more positions based on external signal information, wherein the positions are determined at a position fix rate. In an example, the mobile device 105 is configured to extract position data from a plurality of signals 112 transmitted by GNSS satellites 110. Typically, a position fix rate may be in the range of 1-5 positions determined every second (e.g., 1-5 Hz). The position fix rate may be lowered to less than 1 Hz in an effort to conserve power (e.g., reduce the amount of power consumed by reducing the number of calculations performed). In an example, the mobile device 105 may be configured to determine one or more positions based on terrestrial signals received from a base transceiver station 120 or an access point 130 (e.g., RSSI, RTT). The one or more positions may be determined by the mobile device 105, or by the location server 160 (e.g., based on signal received by the mobile device 105 and provided to the location server 160). The position fix rate may be based on a default value (e.g., an initial fix rate) and may be adjusted based on a quality of service value. The one or more positions, and/or the data extracted from received signals (e.g., SPS signals 112, or information provided over wireless communication links 122, 132) may be stored in the mobile device 105 with an appropriate time stamp for subsequent non-causal analysis as described herein.

At stage 504, the mobile device 105 stores sensor information associated with one or more sensors at a sensor sampling rate. The mobile device 105 may utilize one or more orientation sensors, including one or more gyroscope(s) 210, magnetometer(s) 220 (e.g., compass(es)), accelerometer(s) 230, and/or camera(s) 240. Data from one or more other sensor(s) 250, such as altimeter(s), microphone(s), light sensor(s), proximity sensor(s) may also be used. In an example, the accelerometers 230, or other sensors, may be used as a pedometer to measure a user's foot falls. The sensor information may be used to determine a dead reckoning position (e.g., course, speed, altitude). The mobile device 105 may be configured to store the raw sensor data (e.g., including noise and error components), as well as smoothed data (e.g., via a filtering process). The mobile device 105 may also be configured to store dead reckoning positions (e.g., latitude/longitude/altitude) based on the sensor information. The sensor information and corresponding position information may be stored in the mobile device 105 with the corresponding timestamp information for subsequent non-causal analysis as described herein.

At stage 506, the mobile device 105 calculates a position estimate based on a non-causal analysis of the one or more positions and the sensor information, wherein the non-causal analysis utilizes past, present and future positions and the corresponding past, present and future sensor information. For example, referring to FIG. 3, after time t₅, the mobile device may have stored in memory positions based on external signal information such as the first GNSS position 302 and the second GNSS position 310. The positions and/or corresponding signal information may be stored in memory on the mobile device 105 (or the location server 160). Sensor information from time t₁ to after time t₅ may also be stored. The mobile device 105 (or the location server 160) is configured to determine non-causal positioning based on measurements from the past, present and future to provide the location estimates (e.g. using an forward-backward Extended Kalman Filter (EKF) smoother to improve past position estimates based on future position estimates). For example, the second non-causal DR position 306b associated with time t₃ may be determined after time t₅. In this manner, an estimate of the position accuracy based on the combination of external signals (e.g., GNSS, RSSI, RTT) and sensor (e.g., accelerometers, gyroscopes, etc.) is maintained continuously and may be used to test a hypothesis that a new external signal based fix is necessary for accuracy of past, present & future positions to meet a non-causal Quality of Service (QoS). In an embodiment, the position estimate may be constrained by context information, such as map data stored on a map server 170.

At stage 508, the mobile device 105 compares the position estimate to a QoS value. The QoS value may be associated with a positioning application, and in general, may indicate an acceptable uncertainty level of a position estimate. The QoS value may have an accuracy component (e.g., 1 m, 5 m, 10 m, etc.), a response time component (e.g., 1 sec, 5 sec, 10 sec, etc.), or a combination of both. For example, a fitness application executing on the mobile device 105 may utilize the non-causal analysis of position and sensor data to capture an accurate route traversed by a user. QoS value may require a higher accuracy component (e.g., 5 m), but a reduced response time component (e.g., 10 sec or higher). The non-causal positioning may enable power savings within the mobile device 105 because the resulting non-causal position estimates are obtained at lower signal and sensor sampling rates. In pedestrian applications, for example, the position accuracy of non-causal 1/60 Hz GNSS sampling combined with sensor and map data may produce position estimates that are comparable to 1 Hz GNSS sampling. These results are exemplary only, and not a limitation as the process 500 is iterative and the respective sampling rates may be modified based on the results of the non-causal position estimates in view of the QoS value.

At stage 510, the mobile device 105 modifies the position fix rate based on the comparison of the position estimated calculated at stage 506 and the QoS value. In an example, if the accuracy of a non-causal position estimate is low (e.g., a high uncertainty) then the comparison to the QoS at stage 508 may indicate that the external signal fix rate should increase. The amount of increase in the rate may be established by the position application. In an example, the modification to the position fix rate may be proportional to the area of uncertainty of the non-causal position estimate. Other methods for modifying the position fix rate based on the QoS value may be used. For example, a look-up-table including position estimate parameters and position fix rates may be used. The position fix rate may include a single fix or a predefined series of fixes (2, 3, 5, 10, etc.) over a period of time (e.g., 0.5, 1, 2, 5, 10, 60 seconds). The mobile device 105 may be configured to select a position fix rate required to meet the non-causal QoS based on an estimated sensor error growth, a position fix quality (e.g., GNSS quality), and availability of context information (e.g., map-aiding).

At stage 512, the mobile device 105 modifies the sensor sample rate based on the comparison of the position estimate to the QoS value. In an example, the sensor sample rate may remain constant when the position fix rate is modified at stage 510. The sensor information stored at stage 504 may include an error growth rate based on the sensitivity of the sensor and the characteristics of the route. For example, a path with several short legs (e.g., multiple turns) may impact the uncertainty of a dead reckoning position based on the sensor input. The non-causal analysis performed at stage 506 may utilize map data (e.g., context information) to determine the accuracy of the dead reckoning position. The results of the non-causal analysis of the sensor based dead reckoning positions may be compared to the QoS value and the sensor sample rate may be modified based on the comparison. In general, sensor accuracy may be improved using past, present and future sensor measurements. If a non-causal sensor based dead reckoning position is within (i.e., more accurate) than the QoS, then the sensor sample rate may be reduced. Such a reduction in sensor sample rate may cause a reduction in power consumption in the mobile device. Conversely, if the uncertainty values of one or more non-causal dead reckoning positions exceed the QoS value, the sensor sample rate may be increased. The position fix rate and the sensor sample rate may be modified simultaneously or independently, at the same or at different rates. In an example, the position fix rate may be modified while the sensor sample rate is unchanged, or the position fix rate may remain constant and the sensor sample rate may be modified, based on the comparison to the QoS value.

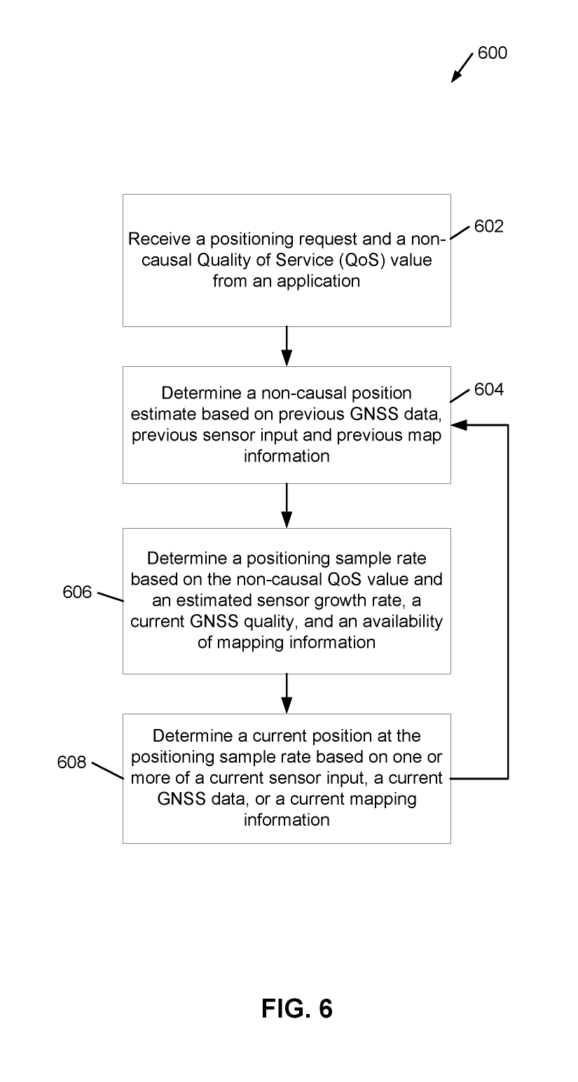

Referring to FIG. 6, with further reference to FIGS. 1-4, a method 600 for controlling based on a non-causal quality of service value includes the stages shown. The method 600 is, however, an example only and not limiting. The method 600 can be altered, e.g., by having stages added, removed, rearranged, combined, performed concurrently, and/or having single stages split into multiple stages.

At stage 602, the method includes receiving a positioning request and a Quality of Service (QoS) value from an application. The mobile device 105 may include one or more positioning applications configured to compute and store historical position information, such as workout (i.e., running/jogging) routes. A positioning request from such an application may not require real-time position calculations (i.e., based on a causal positioning method), but may place a great emphasis on the accuracy of the historical position information. A non-causal positioning method may be used and the positioning request may include a non-causal Quality of Service (QoS) value to establish the acceptable accuracy of the resulting position estimates. In general, a higher QoS implies higher sampling rates for GNSS and/or sensor data (i.e., more accurate position estimates). The QoS value may be included in the positioning request, or it may be associated with the application via an additional data source (e.g., look-up-table, configuration settings, default values).

At stage 604, the method includes determining a non-causal position estimate based on previous GNSS data, previous sensor input and previous map information. The GNSS data may include signal information and/or GNSS position estimates received or determined by the mobile device 105. In an example, other external signals may be used by the mobile device 105 to determine one or more positions (e.g., based on terrestrial signals received from a base transceiver station 120 or an access point 130). The previous sensor input may include sensor logs (i.e., data stored in memory) from other sensors on the mobile device 105. The mobile device 105 may store information obtained from one or more orientation sensors, including one or more gyroscope(s) 210, magnetometer(s) 220 (e.g., compass(es)), accelerometer(s) 230, and/or camera(s) 240. Data from one or more other sensor(s) 250, such as altimeter(s), microphone(s), light sensor(s), proximity sensor(s) may also be stored. Map information may also be stored on the mobile device 105 and used in determining the non-causal position estimate. For example, referring to FIG. 3, after time t₅ the mobile device 105, or a location server 160, may determine the third non-causal DR position 308b based on the first GNSS position 302, the second GNSS position 310, sensor input received after time t₁, and associated map data. The non-causal position estimate may be based on a central moving average algorithm as applied to the sensor signals or other position calculations (e.g., based on GNSS data). Other non-causal data analysis techniques may also be used.

At stage 606, the method includes determining a positioning sampling rate based on the non-causal QoS and an estimated sensor growth rate, a current GNSS quality, and an availability of mapping information. The non-causal QoS value received at stage 602 may be used as a threshold value to evaluate the quality of a position estimate. In general, a higher the QoS value implies an increase is the sample rate (i.e., more frequent fixes and sensor input). The quality of a position estimate may also be impacted by inherent limitations of external signals and the inertial sensors. For example, GNSS quality may be degraded if the mobile device 105 is located indoors, within a canyon, or other locations that may obscure or obstruct satellite signals. Inertial sensors may have error growth rates based on other physical factors such as sensor orientation (e.g., in a cradle, worn on an arm band, carried in a pant pocket, etc.) or the nature of the travelled path (e.g., straight, zig-zag, shallow incline, etc.). The non-causal analysis of the sensor input may be used to estimate a sensor growth rate. The position and sensor data may be constrained or adjusted based on context information such as map data (e.g., indicating paths, altitude information, proximate WiFi signals, etc.). The mobile device 105 is configured to determine a sensor sample rate based on this analysis in view of the requested QoS value. The position sample rate may include the periodicity of GNSS fixes and sensor sampling rates. As an example, and not a limitation, the positioning sample rate may include obtaining and processing GNSS signals and inertial sensor input at rates between 0.01 and 60 Hz. The GNSS signal and inertial sensor input sampling rates may be different such that GNSS positions are obtained at a lower frequency than the inertial sensor input. The method 600 may be performed iteratively such that an estimate of the combined GNSS, sensor, and map-aided position accuracy may be maintained continuously and used to test a hypothesis that new a GNSS position estimate is necessary for accuracy of past, present & future positions to meet the non-causal QoS value.

At stage 608, the method includes determining a current position at the positioning sampling rate based on one or more of a current sensor input, a current GNSS data, or current mapping information. The mobile device 105 is configured to determine GNSS positions based on received satellite signals. In an example, the mobile device 105 may also use terrestrial signals (e.g., RSSI, RTT) to determine a current position. Inertial sensor input may be used to calculate a dead reckoning position. In an example, visible light communication (VLC) technology may be used with the camera 240 on the mobile device 105 to establish a current position. Map data and other context information may be used to determine the current position of the mobile device 105. For example, referring to FIG. 3, the mobile device 105 is configured to determine the first GNSS position 302 at time t₁ and the first DR position 304a at time t₂. The current position and/or corresponding data determined at stage 608 may be subsequently used in a non-causal analysis at stage 604 to determine the non-causal position estimate.

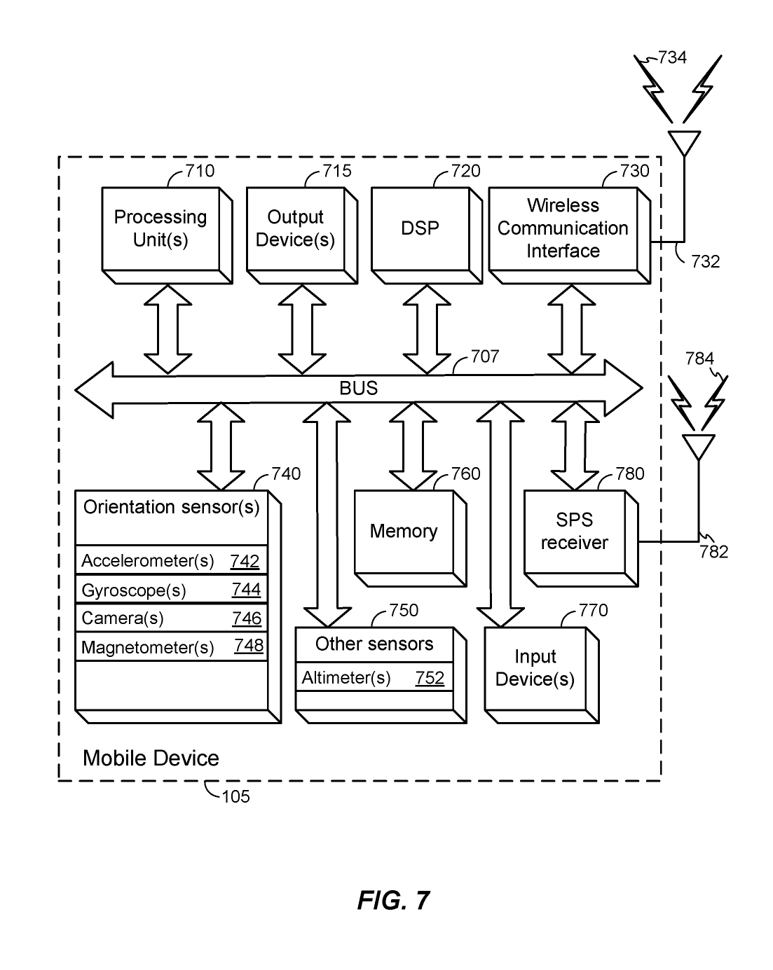

Referring to FIG. 7, a block diagram of an example mobile device 105 is shown. The mobile device 105 may be utilized in the positioning system 100 of FIG. 1, and/or that can be configured to perform the methods provided by various other embodiments, such as those described in relation to FIGS. 5 and 6. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

It can also be noted that some or all of the components of the mobile device 105 shown in FIG. 7 can be utilized in other computing systems described herein, such as location server(s), map server(s), and/or access point(s) 130 of FIG. 1. In these other systems, as well as the mobile device 105, it can be noted that components illustrated by FIG. 7 can be localized to a single device and/or distributed among various networked devices, which may be disposed at different physical locations.

The mobile device 105 is shown comprising hardware elements that can be electrically coupled via a bus 707 (or may otherwise be in communication, as appropriate). The hardware elements may include a processing unit(s) 710 which can include without limitation one or more general-purpose processors, one or more special-purpose processors (such as digital signal processing (DSP) chips, graphics acceleration processors, application specific integrated circuits (ASICs), and/or the like), and/or other processing structure or means, which can be configured to perform one or more of the methods described herein, including methods illustrated in FIGS. 5 and 6. As shown in FIG. 7, some embodiments may have a separate DSP 720, depending on desired functionality. The mobile device 105 also can include one or more input devices 770, which can include without limitation a touch screen, a touch pad, microphone, button(s), dial(s), switch(es), and/or the like; and one or more output devices 715, which can include without limitation a display, light emitting diode (LED), speakers, and/or the like.

The mobile device 105 might also include a wireless communication interface 730, which can include without limitation a modem, a network card, an infrared communication device, a wireless communication device, and/or a chipset (such as a Bluetooth™ device, an IEEE 802.11 device, an IEEE 802.15.4 device, a WiFi device, a WiMax device, cellular communication facilities (as described above), etc.), and/or the like. The wireless communication interface 730 may permit data to be exchanged with a network (such as the Internet 150 and/or mobile network provider 140 of FIG. 1), other computer systems, and/or any other electronic devices described herein. The communication can be carried out via one or more wireless communication antenna(s) 732 that send and/or receive wireless signals 734. Depending on desired functionality, the mobile device 105 can include separate transceivers to communicate with base transceiver stations (e.g., base transceiver station(s) 120 of FIG. 1) and access points (e.g., access point(s) 130 of FIG. 1). The communication interface 730 and the processing unit(s) 710 may be a means for determining a position based on RSSI and RTT information.

The mobile device 105 can further include orientation sensor(s) 740. As indicated herein, orientation sensors can include sensors from which an orientation of the mobile device 105 can be determined. Such sensors can include, without limitation, one or more accelerometer(s) 742, gyroscope(s) 744, camera(s) 746, magnetometer(s) 748, and the like. These orientation sensor(s) 740 can correspond to the accelerometer(s) 230, gyroscope(s) 210, camera(s) 240, and magnetometer(s) 220 shown in FIG. 2 and described previously. The mobile device 105 may further include other sensor(s) 750 such as one or more altimeter(s) 752, as described above. Moreover, other sensor(s) 750 also can include sensor(s) not shown in FIG. 7, such as microphone(s), proximity sensor(s), light sensor(s), and the like. The orientation sensor(s) 740, in combination with the processing unit(s) 710 and memory 760, may be means for storing sensor information.

Embodiments of the mobile device may also include an Satellite Positioning System (SPS) receiver 780 capable of receiving signals 784 from one or more SPS satellites (such as the GNSS satellites 110 of FIG. 1) using an SPS antenna 782. The SPS receive 780 and/or the wireless communication interface 730, in combination with the processing unit(s) 710, may be a means for determining one or more positions based on external signal information.

The mobile device 105 may further include (and/or be in communication with) a memory 760. The memory 760 can include, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The memory 760 of the mobile device 105 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above, such as those described in relation to FIGS. 5 and 6, might be implemented as code and/or instructions executable by the mobile device 105 (and/or a processing unit within a mobile device 105) (and/or another device of a positioning system). In an aspect, then, such code and/or instructions can be used to configure and/or adapt a general purpose computer (or other device) to perform one or more operations in accordance with the described methods. The processing unit(s) 710 and the memory 760 may be a means for calculating a position estimate based on a non-causal analysis of one or more positions and sensor information, a means for comparing the position estimate to a Quality of Service (QoS) value, and a means for modifying a position fix rate and/or a sensor sampling rate (e.g., a means for reducing the position fix rate).

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the mobile device 105) to perform methods in accordance with various embodiments of the invention. According to a set of embodiments, some or all of the procedures of such methods are performed by the mobile device 105 in response to processing unit(s) 710 executing one or more sequences of one or more instructions (which might be incorporated into an operating system and/or other code) contained in the memory 760. Merely by way of example, execution of the sequences of instructions contained in the memory 760 might cause the processing unit(s) 710 to perform one or more procedures of the methods described herein. Additionally or alternatively, portions of the methods described herein may be executed through specialized hardware.

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of or prefaced by “one or more of indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may include processor-readable instructions involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Further, more than one invention may be disclosed.

1. A method for controlling a sampling rate in a mobile device, comprising:
determining one or more positions based on external signal information, wherein the one or more positions are determined at a position fix rate;
storing sensor information associated with one or more sensors at a sensor sampling rate;
calculating a position estimate based on a non-causal analysis of the one or more positions and the sensor information, wherein the non-causal analysis utilizes past, present and future positions and the corresponding past, present and future sensor information;
comparing the position estimate to a Quality of Service (QoS) value; and
modifying the position fix rate based on the comparison of the position estimate to the QoS value.

2. The method of claim 1 further comprising modifying the sensor sampling rate based on the comparison of the position estimate to the QoS value.

3. The method of claim 1 wherein the external signal information is a signal received from a Global Navigation Satellite System (GNSS).

4. The method of claim 1 wherein the external signal information is a terrestrial position signal.

5. The method of claim 4 wherein the mobile device is configured to determine the one or more positions based on a Received Signal Strength Indication (RSSI) or a Round Trip Time (RTT) associated with the terrestrial position signal.

6. The method of claim 1 wherein the QoS value includes an accuracy component.

7. The method of claim 1 wherein the QoS value includes a response time component.

8. The method of claim 1 wherein modifying the position fix rate includes reducing the position fix rate from 1 Hz to less than 0.5 Hz.

9. An apparatus, comprising:
a memory;
at least one processor operably coupled to the memory and configured to:
determine one or more positions based on external signal information, wherein the one or more positions are determined at a position fix rate;
store sensor information associated with one or more sensors at a sensor sampling rate in the memory;
calculate a position estimate based on a non-causal analysis of the one or more positions and the sensor information, wherein the non-causal analysis utilizes past, present and future positions and the corresponding past, present and future sensor information;
compare the position estimate to a Quality of Service (QoS) value; and
modify the position fix rate based on the comparison of the position estimate to the QoS value.

10. The apparatus of claim 9 wherein the at least one processor is further configured to modify the sensor sampling rate based on the comparison of the position estimate to the QoS value.

11. The apparatus of claim 9 further comprising a Satellite Positioning System (SPS) receiver and the external signal information is a signal received from a Global Navigation Satellite System (GNSS).

12. The apparatus of claim 9 further comprising a wireless communication interface and the external signal information is a terrestrial position signal.

13. The apparatus of claim 12 wherein the at least one processor is configured to determine the one or more positions based on a Received Signal Strength Indication (RSSI) or a Round Trip Time (RTT) associated with the terrestrial position signal.

14. The apparatus of claim 9 wherein the QoS value includes an accuracy component.

15. The apparatus of claim 9 wherein the QoS value includes a response time component.

16. The apparatus of claim 9 wherein the at least one processor is configured to modify the position fix rate by reducing the position fix rate from 1 Hz to less than 0.5 Hz.

17. An apparatus for controlling a sampling rate in a mobile device, comprising:
means for determining one or more positions based on external signal information, wherein the one or more positions are determined at a position fix rate;
means for storing sensor information associated with one or more sensors at a sensor sampling rate;
means for calculating a position estimate based on a non-causal analysis of the one or more positions and the sensor information, wherein the non-causal analysis utilizes past, present and future positions and the corresponding past, present and future sensor information;
means for comparing the position estimate to a Quality of Service (QoS) value; and
means for modifying the position fix rate based on the comparison of the position estimate to the QoS value.

18. The apparatus of claim 17 further comprising means for modifying the sensor sampling rate based on the comparison of the position estimate to the QoS value.

19. The apparatus of claim 17 wherein the external signal information is a signal received from a Global Navigation Satellite System (GNSS).

20. The apparatus of claim 17 wherein the external signal information is a terrestrial position signal.

21. The apparatus of claim 20 comprising means for determining the one or more positions based on a Received Signal Strength Indication (RSSI) or a Round Trip Time (RTT) associated with the terrestrial position signal.

22. The apparatus of claim 17 wherein the QoS value includes an accuracy component.

23. The apparatus of claim 17 wherein the QoS value includes a response time component.

24. The apparatus of claim 17 wherein the means for modifying the position fix rate includes means for reducing the position fix rate from 1 Hz to less than 0.5 Hz.

25. A non-transitory processor-readable storage medium comprising processor-readable instructions configured to cause one or more processing units to control a sampling rate in a mobile device, comprising:
code for determining one or more positions based on external signal information, wherein the one or more positions are determined at a position fix rate;
code for storing sensor information associated with one or more sensors at a sensor sampling rate;
code for calculating a position estimate based on a non-causal analysis of the one or more positions and the sensor information, wherein the non-causal analysis utilizes past, present and future positions and the corresponding past, present and future sensor information;
code for comparing the position estimate to a Quality of Service (QoS) value; and
code for modifying the position fix rate based on the comparison of the position estimate to the QoS value.

26. The storage medium of claim 25 further comprising code for modifying the sensor sampling rate based on the comparison of the position estimate to the QoS value.

27. The storage medium of claim 25 wherein the external signal information is a signal received from a Global Navigation Satellite System (GNSS).

28. The storage medium of claim 25 wherein the external signal information is a terrestrial position signal.

29. The storage medium of claim 28 comprising code for determining the one or more positions based on a Received Signal Strength Indication (RSSI) or a Round Trip Time (RTT) associated with the terrestrial position signal.

30. The storage medium of claim 25 wherein the code for modifying the position fix rate includes code for reducing the position fix rate from 1 Hz to less than 0.5 Hz.
